(19) United States
(12) Patent Application Publication
(10) Pub. No.: US 2025/0306286 A1
(43) Pub. Date: Oct. 2, 2025

(54) OPTICAL WAVEGUIDE COMPONENT AND METHOD OF MAKING OPTICAL WAVEGUIDE COMPONENT

(71) Applicant: SHINKO ELECTRIC INDUSTRIES CO., LTD., Nagano (JP)

(72) Inventor: Kenichi MORI, Nagano (JP)

(21) Appl. No.: 19/088,042

(22) Filed: Mar. 24, 2025

(30) Foreign Application Priority Data
Mar. 29, 2024 (JP) 2024-056300

(51) Int. Cl. G02B 6/30

(52) U.S. Cl. CPC G02B 6/30

(57) ABSTRACT

An optical waveguide component includes a substrate having a first surface, an optical waveguide disposed on the first surface, a projection formed on the first surface, a glass block including an optical fiber and including a recess into which the projection fits, wherein the optical waveguide and the optical fiber are optically coupled.

### CROSS-REFERENCE TO RELATED APPLICATIONS

The present application is based upon and claims the benefit of priority from the prior Japanese Patent Application No. 2024-056300 filed on Mar. 29, 2024, with the Japanese Patent Office, the entire contents of which are incorporated herein by reference.

### FIELD

The disclosures herein relate to optical waveguide components and methods of making an optical waveguide component.

### BACKGROUND

An optical waveguide component of a certain type includes a polymer waveguide provided on a substrate and an optical fiber provided in a glass block. In the manufacture of such an optical waveguide component, optical coupling between the polymer waveguide and the optical fiber involves aligning optical axes and applying an ultraviolet curable adhesive, followed by curing the adhesive by ultraviolet light irradiation.

Recently, there has been a growing demand to reduce the time required for manufacturing optical waveguide components.

There may be a need to provide an optical waveguide component and a method of making the optical waveguide component that enable the reduction of manufacturing time.

### PRIOR ART DOCUMENTS

### Patent Document

[Patent document 1] Japanese Laid-open Patent Publication No. 2022-509356

[Patent document 2] Japanese Laid-open Patent Publication No. 2018-040925

[Patent document 3] Japanese Laid-open Patent Publication No. 2005-326602

### SUMMARY

According to an aspect of the embodiment, an optical waveguide component includes a substrate having a first surface, an optical waveguide disposed on the first surface, a projection formed on the first surface, a glass block including an optical fiber and including a recess into which the projection fits, wherein the optical waveguide and the optical fiber are optically coupled.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is an oblique view illustrating an example of an optical waveguide component according to a first embodiment;

FIG. 2 is an oblique view illustrating an example of a method of making the optical waveguide component according to the first embodiment;

FIG. 3 is an oblique view illustrating the example of the method of making the optical waveguide component according to the first embodiment;

FIG. 4 is an oblique view illustrating the example of the method of making the optical waveguide component according to the first embodiment;

FIG. 5 is an oblique view illustrating the example of the method of making the optical waveguide component according to the first embodiment;

FIG. 6 is an oblique view illustrating the example of the method of making the optical waveguide component according to the first embodiment;

FIG. 7 is an oblique view illustrating the example of the method of making the optical waveguide component according to the first embodiment;

FIG. 8 is an oblique view illustrating the example of the method of making the optical waveguide component according to the first embodiment;

FIG. 9 is a cross-sectional view illustrating an example of an optical waveguide component according to a second embodiment; and

FIG. 10 is a cross-sectional view illustrating an example of an optical waveguide component according to a third embodiment.

### DESCRIPTION OF EMBODIMENTS

In the following, embodiments of the present invention will be described with reference to the accompanying drawings.

In the following, embodiments of the present disclosures will be described with reference to the accompanying drawings. In the instant application and the drawings, components having substantially the same functional configuration are referred to by the same reference numerals, and a description thereof may be omitted as appropriate.

### First Embodiment

The first embodiment is described below. The first embodiment is directed to an optical waveguide component.

### [Structure of Optical Waveguide Component]

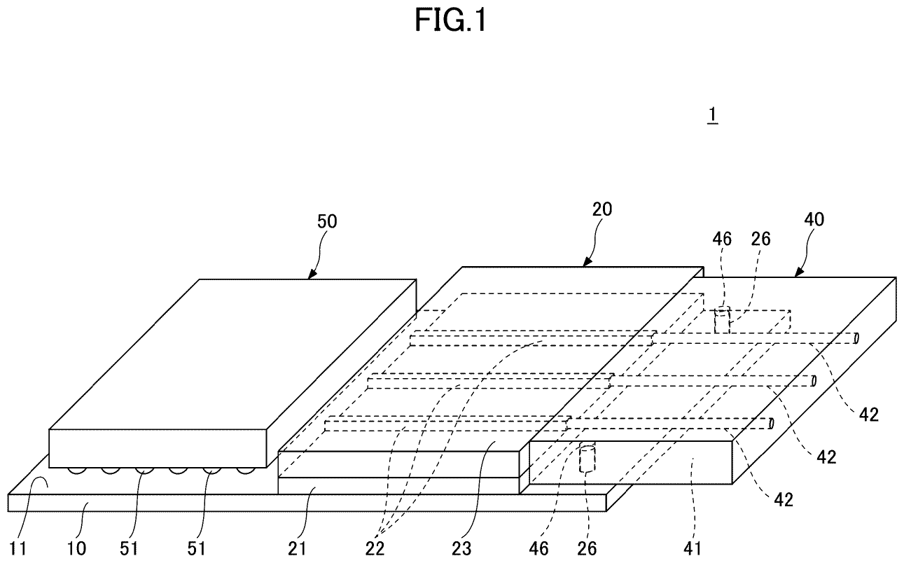

The structure of an optical waveguide component according to the first embodiment is described below. FIG. 1 is an oblique view illustrating an example of an optical waveguide component according to the first embodiment.

As illustrated in FIG. 1, an optical waveguide component 1 according to the first embodiment includes a substrate 10, an optical waveguide 20, one or more projections 26, a glass block 40, and an optical semiconductor chip 50.

The substrate 10 is, for example, an interconnect substrate, and includes an interconnect pattern (not illustrated) and an electrode (not illustrated). The substrate 10 has a first surface 11. The optical waveguide 20 and the projections 26 are provided on the first surface 11 of the substrate 10.

In this embodiment, for convenience, the side of the substrate 10 where the optical waveguide 20 is located is referred to as an upper side or a first side, and the opposite side is referred to as a lower side or a second side. The surface of the upper side of an object is referred to as a first surface or an upper surface, and the surface of the lower side is referred to as a second surface or a lower surface. However, the optical waveguide component 1 may be positioned upside down when used or may be arranged at any angle. The plan view refers to the view of an object as seen from the direction normal to the first surface of the substrate 10, and the plane shape refers to the shape of an object as seen from the direction normal to the first surface of the substrate 10.

The optical waveguide 20 includes a first cladding layer 21, a plurality of cores 22, and a second cladding layer 23. The optical waveguide 20 is a polymer waveguide.

The first cladding layer 21 is disposed on the surface 11 of the substrate 10. The material of the first cladding layer 21 is an organic resin such as epoxy resin or polyimide resin. The thickness of the first cladding layer 21 is, for example, about 10 μm to 30 μm.

The plurality of cores 22 are each disposed on the first cladding layer 21 in a bar form. The material of the cores 22 is an organic resin such as epoxy resin or polyimide resin. The cross-sectional shape of each core 22 perpendicular to its longitudinal direction is rectangular. In order to provide a single-mode optical waveguide, each core 22 may have a small cross-sectional area. For example, the width of the core 22 is 5 μm to 10 μm, and the height is 5 μm to 10 μm.

The second cladding layer 23 is provided on the first cladding layer 21 and the plurality of cores 22. The second cladding layer 23 covers the plurality of cores 22. The material of the second cladding layer 23 is organic resin such as epoxy resin or polyimide resin. The thickness of the second cladding layer 23 is, for example, about 10 μm to 30 μm.

In the optical waveguide 20, the refractive index of the cores 22 is higher than those of the first cladding layer 21 and the second cladding layer 23.

The optical semiconductor chip 50 includes optical elements (not illustrated) and is mounted on the substrate 10. The optical semiconductor chip 50 has a plurality of electrodes 51 and is flip-chip mounted on the substrate 10. The optical semiconductor chip 50 is disposed beside the cores 22, on one side along their extending direction, and the optical elements are optically coupled to the optical waveguide 20. Each optical element may be either a light receiving element or a light emitting element.

The projections 26 are disposed on the other side along the extending direction of the cores 22. In plan view, the optical waveguide 20 is positioned between the optical semiconductor chip 50 and the projections 26. The number of projections 26 are, for example, two or more. The projections 26 have a cylindrical shape. In plan view, the diameters of the projections 26 are, for example, about 50 μm to 500 μm. The projections 26 are formed of, for example, the same material as the first cladding layer 21. The heights of the projections 26 may be equal to the thickness of the first cladding layer 21. The projections 26 are located further out than the outermost two cores 22 in the direction in which the plurality of cores 22 are arrayed (i.e., the direction perpendicular to their extending direction).

The glass block 40 includes optical fibers 42. For example, the cross-sectional shapes of the cores of the optical fibers 42 perpendicular to their extending direction are circular. The diameters of the cores of the optical fibers 42 are, for example, about 127 μm to 250 μm. The optical waveguide 20 and the optical fibers 42 are optically coupled to each other.

The glass block 40 has recesses 46 formed therein into which the projections 26 snugly fit. The recesses 46 are provided to correspond in number to the projections 26. The recesses 46 each have a cylindrical shape. The diameters of the recesses 46 in plan view are, for example, about 51 μm to 501 μm. The depths of the recesses 46 are slightly greater than the heights of the projections 26. The depths of the recesses 46 may alternatively be equal to the heights of the projections 26. The recesses 46 are formed on the lower surface 41 of the glass block 40.

The glass block 40 is bonded to the first cladding layer 21 and the cores 22 by the second cladding layer 23.

### [Method of Making Optical Waveguide Component]

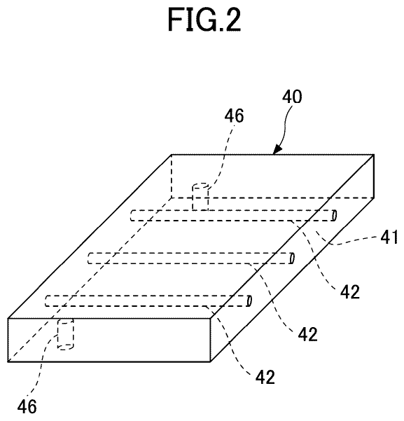

In the following, a method of making an optical waveguide component according to the first embodiment will be described. FIGS. 2 to 8 are oblique views illustrating a method of making an optical waveguide component according to the first embodiment.

As illustrated in FIG. 2, the glass block 40 is prepared. The glass block 40 includes the optical fibers 42. The recesses 46 are formed in the lower surface 41 of the glass block 40. The recesses 46 may be formed by drilling, for example.

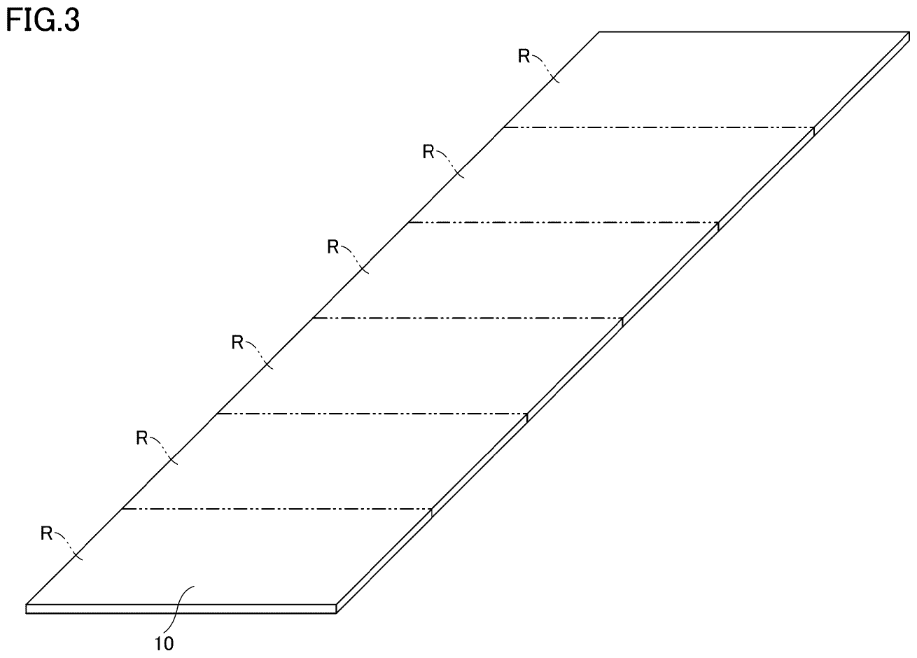

Further, illustrated in FIG. 3, the substrate 10 is prepared. The substrate 10 is formed of an insulating resin material such as glass epoxy resin. The substrate 10 may be a rigid substrate with high rigidity or a flexible substrate with low rigidity. The substrate 10 includes an insulator referred to as a support or a base. The substrate 10 is a large-scale substrate designed for singulation with a plurality of partitioned product regions R, and are cut along the boundaries between the product regions R in the end, thereby producing individual optical waveguide components.

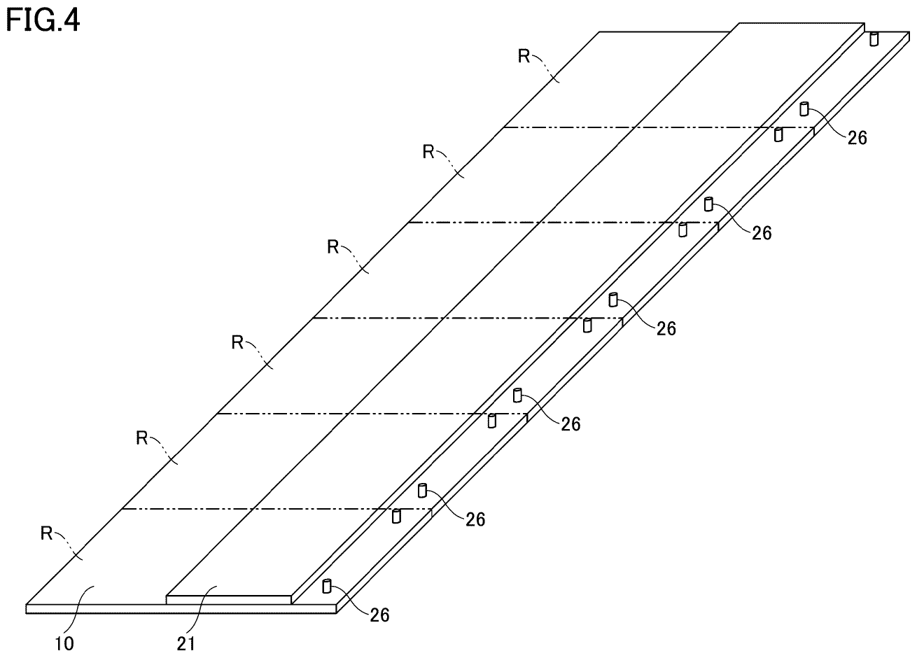

As illustrated in FIG. 4, the first cladding layer 21 and the projections 26 are formed on the substrate 10. The first cladding layer 21 is formed all at once over the plurality of product regions R. In order to form the first cladding layer 21 and the projections 26, for example, an ultraviolet curable resin is formed, exposed, developed, and then heated in this order. The method of forming the ultraviolet curable resin may involve attaching a resin sheet or applying a liquid resin. The temperature of the heat treatment is, for example, 150° C. to 200° C.

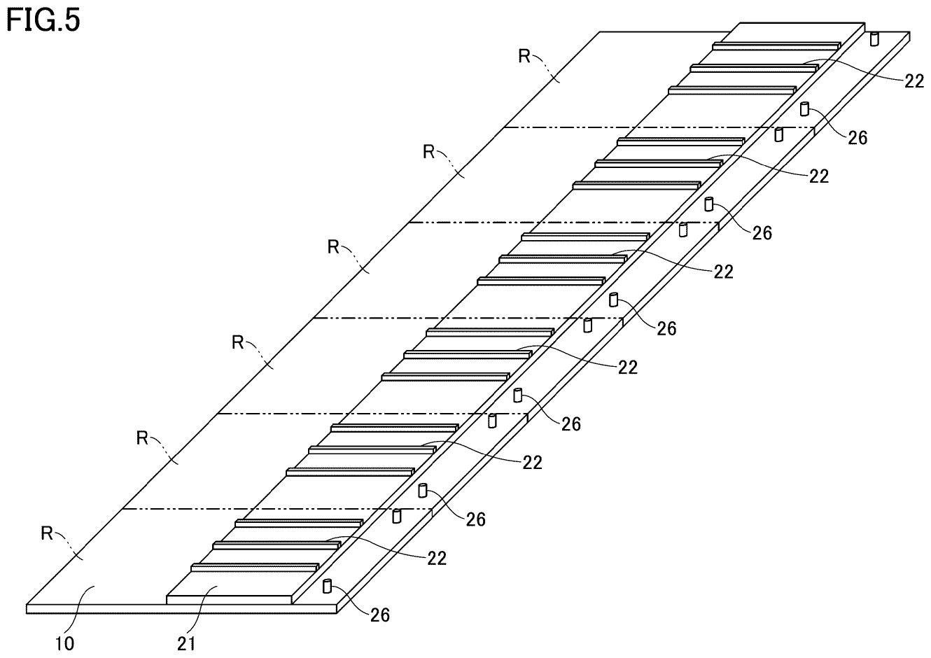

As illustrated in FIG. 5, the plurality of cores 22 are formed on the first cladding layer 21 in a bar form. In order to form the cores 22, for example, an ultraviolet curable resin is formed, exposed, developed, and then heated in this order.

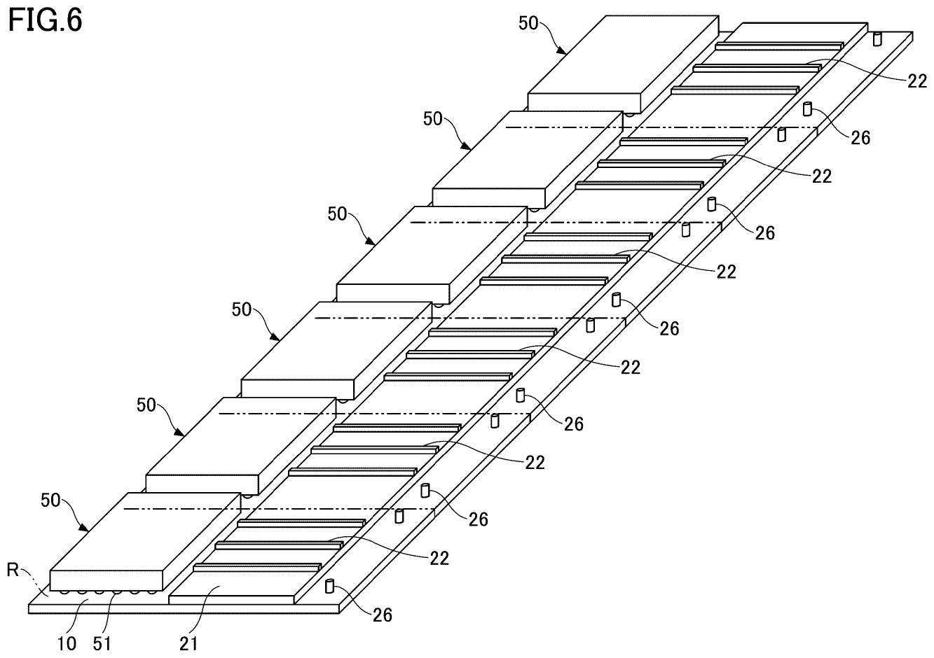

Subsequently, as illustrated in FIG. 6, the optical semiconductor chip 50 is mounted on the substrate 10 for each product region R.

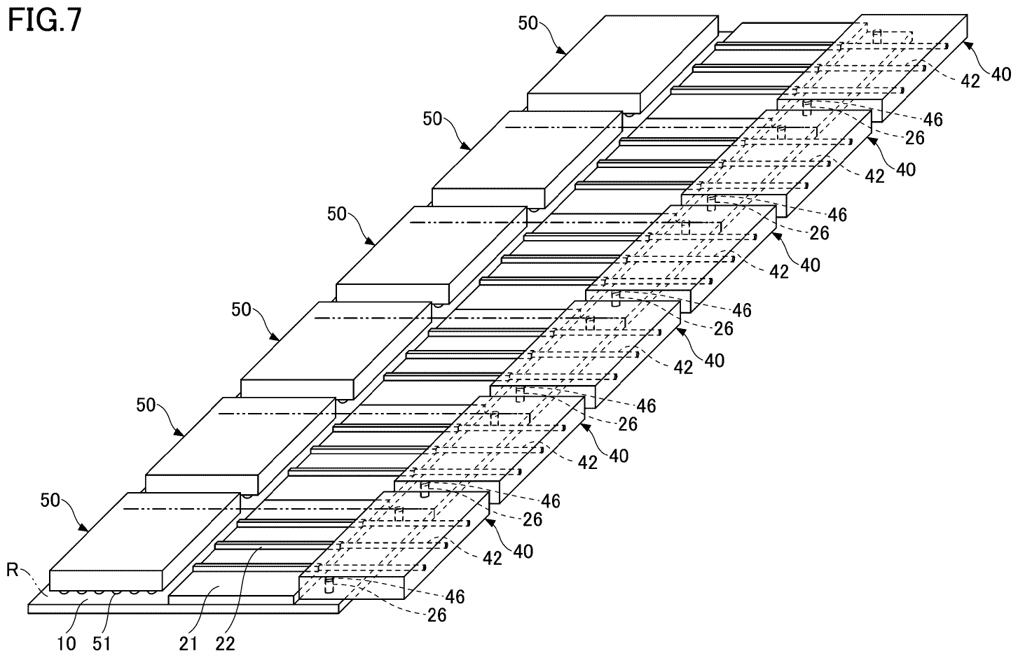

As illustrated in FIG. 7, the glass block 40 is mounted on the substrate 10 for each product region R while fitting the projections 26 to the respective recesses 46. This arrangement optically couples the optical waveguide 20 with the optical fibers 42.

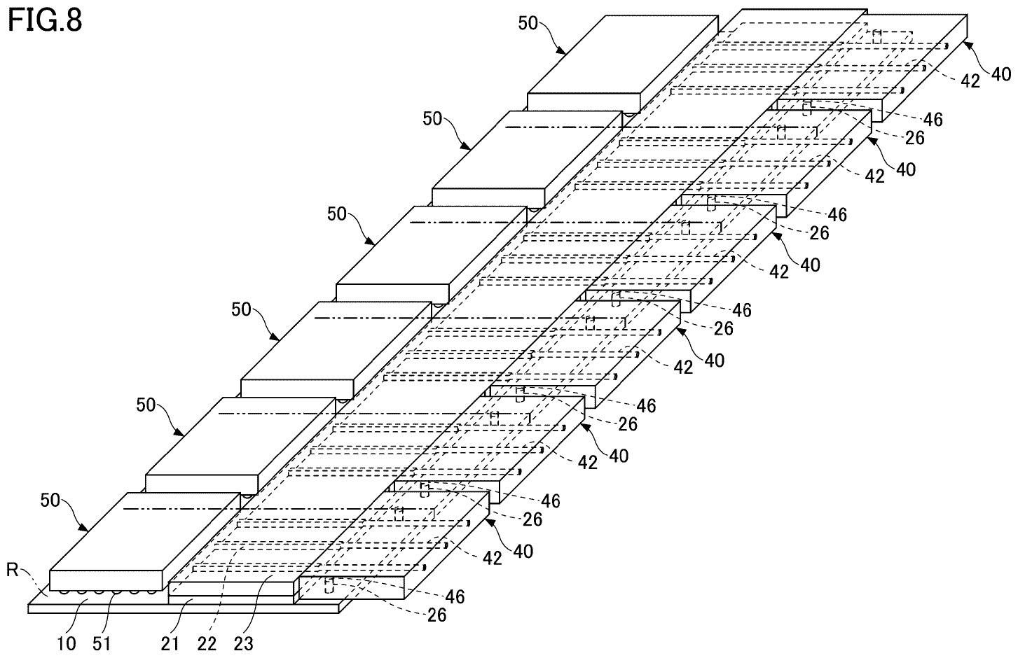

As illustrated in FIG. 8, the second cladding layer 23 is formed on the first cladding layer 21 and the cores 22. The second cladding layer 23 is formed all at once over the plurality of product regions R. The second cladding layer 23 is formed in contact with each glass block 40. In order to form the second cladding layer 23, for example, an ultraviolet curable resin formed, is exposed, developed, and then heated in this order. When the material of the second cladding layer 23 contains an adhesive, the second cladding layer 23 bonds the first cladding layer 21 and the cores 22 to the glass blocks 40.

Subsequently, along the boundaries between the product regions R, the second cladding layer 23, the first cladding layer 21, and the substrate 10 are cut by a rotary blade of a cutting device or the like for singulation. This allows for the production of a plurality of optical waveguide components 1 according to the first embodiment (see FIG. 1).

Through the steps described heretofore, the manufacture of the optical waveguide component 1 according to the first embodiment is effectively achieved.

In the first embodiment, the recesses 46 are formed in the glass block 40, and the projections 26 are provided on the surface 11 of the substrate 10, so that the projections 26 are fitted in the recesses 46. The first cladding layer 21, the cores 22, the second cladding layer 23, and the projections 26 are effectively formed with high positional accuracy by, for example, photolithography. The optical fibers 42 are effectively formed in the glass block 40 with high positional accuracy, and the recesses 46 are also effectively formed in the glass block 40 with high positional accuracy. With this arrangement, passive alignment enables highly accurate optical coupling between the optical waveguide 20 and the optical fibers 42. That is, optical coupling is effectively made with high positional accuracy, without aligning optical axes.

Further, the glass block 40 is effectively bonded to the first cladding layer 21 and the cores 22 by using the second cladding layer 23, which eliminates the need for a separate adhesive for joining the optical waveguide 20 and the glass block 40.

Furthermore, forming the second cladding layer 23 over a plurality of product regions R enables the glass blocks 40 to be simultaneously attached to the substrate 10 for the plurality of product regions R.

Accordingly, the first embodiment enables a reduction in the time required for manufacturing the optical waveguide component 1.

### Second Embodiment

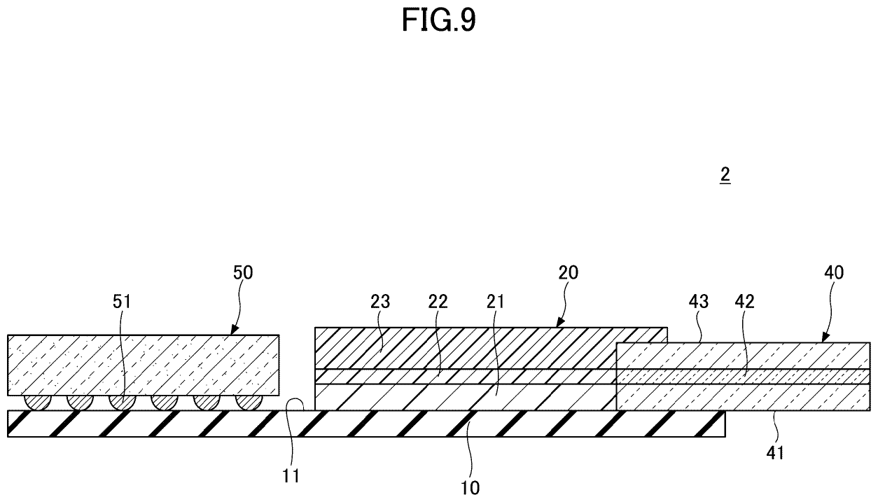

A second embodiment is described below. The second embodiment differs from the first embodiment mainly in the configuration of the second cladding layer. FIG. 9 is a cross-sectional view illustrating an example of an optical waveguide component according to the second embodiment.

As illustrated in FIG. 9, an optical waveguide component 2 according to the second embodiment is configured such that the second cladding layer 23 covers a part of the upper surface 43 of the glass block 40. Other configurations of the second embodiment are the same as those of the first embodiment.

The second embodiment achieves substantially the same advantageous effects as those of the first embodiment. In the second embodiment, the contact area between the second cladding layer 23 and the glass block 40 is larger than that of the first embodiment. This arrangement effectively achieves higher adhesive strength between the glass block 40 and each of the first cladding layer 21 and the cores 22.

### Third Embodiment

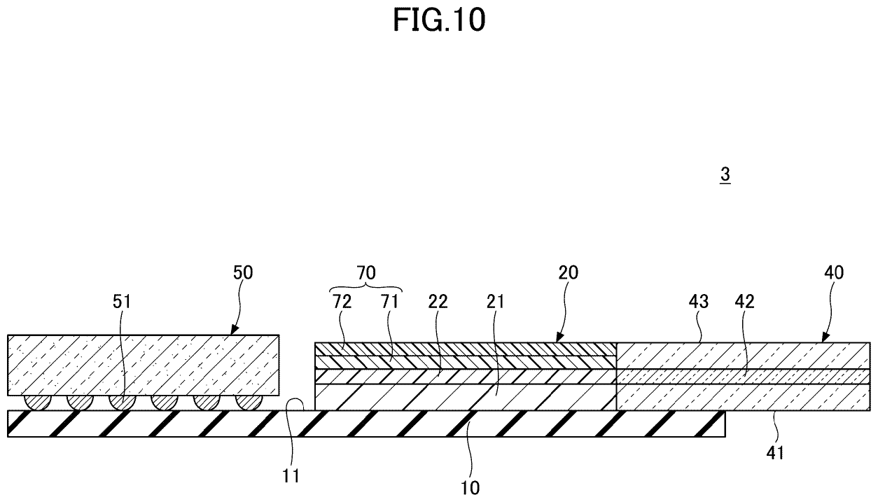

A third embodiment is described below. The third embodiment differs from the first embodiment mainly in the configuration of the second cladding layer. FIG. 10 is a cross-sectional view illustrating an example of an optical waveguide component according to the third embodiment.

As illustrated in FIG. 10, an optical waveguide component 3 according to the third embodiment includes a second cladding layer 70 in place of the second cladding layer 23. The second cladding layer 70 includes a first layer 71 and a second layer 72. The first layer 71 is disposed on the first cladding layer 21 and the plurality of cores 22. The first layer 71 covers the plurality of cores 22. The material of the first layer 71 is substantially the same as that of the second cladding layer 23. The first layer 71 is thinner than the second cladding layer 23, and the thickness of the first layer 71 is, for example, about 5 um to 20 um. The second layer 72 is disposed on the first layer 71. The second layer 72 is formed of a material having higher adhesive strength than the first layer 71. The second layer 72 is thinner than the second cladding layer 23, and the thickness of the second layer 72 is, for example, about 5 μm to 20 μm. The combined thickness of the first layer 71 and the second layer 72 is about the same as that of the second cladding layer 23. Other structures of the third embodiment are the same as those of the first embodiment.

The third embodiment achieves substantially the same effects as those of the first embodiment. In the third embodiment, the second cladding layer 70 includes the first layer 71 and the second layer 72, and the second layer 72 is made of a material having higher adhesive strength than the first layer 71, thereby effectively providing the glass block 40 with higher adhesive strength to the first cladding layer 21 and the cores 22.

During the manufacture of the optical waveguide component 3, for example, the first layer 71 is formed before attaching the glass block 40, and the second layer 72 is formed after attaching the glass block 40.

According to the present disclosures, manufacturing time is effectively reduced.

The present disclosures non-exclusively include the subject matter set out in the following clauses.

Clause 1. A method of making an optical waveguide component, comprising:
forming an optical waveguide and a
projection on a first surface of a substrate;
preparing a glass block including an optical fiber and including a recess formed therein; and
attaching the glass block to the substrate while fitting the projection into the recess, thereby optically coupling the optical waveguide to the optical fiber.

Clause 2. The method according to clause 1, wherein the forming the optical waveguide includes:
forming a first cladding layer on the first surface;
forming a core on the first cladding layer;
forming a second cladding layer on the first cladding layer and the core,
wherein the attaching the glass block to the substrate is performed between the forming the core and the forming the second cladding layer, and
wherein the second cladding layer adheres the first cladding layer and the core layer to the glass block.

Clause 3. The method according to clause 1, wherein the forming the optical waveguide includes:
forming a first cladding layer on the first surface;
forming a core on the first cladding layer;
forming a second cladding layer on the first cladding layer and the core;
wherein the projection is formed simultaneously with the first cladding layer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, and substitutions, alterations could be made hereto without departing from the spirit and scope of the invention.

What is claimed is:

1. An optical waveguide component comprising:
a substrate having a first surface;
an optical waveguide disposed on the first surface;
a projection formed on the first surface;
a glass block including an optical fiber and including a recess into which the projection fits;
wherein the optical waveguide and the optical fiber are optically coupled.

2. The optical waveguide component according to claim 1, comprising a plurality of said projections, wherein the glass block includes a plurality of said recesses equal in number to the projections.

3. The optical waveguide component according to claim 1, wherein the projection has a cylindrical shape, and the recess has a cylindrical shape.

4. The optical waveguide component according to claim 1, wherein the optical waveguide is a polymer waveguide.

5. The optical waveguide component according to claim 1, wherein the optical waveguide includes:
a first cladding layer disposed on the first surface;
a core disposed on the first cladding layer;
a second cladding layer disposed on the first cladding layer and the core, and
wherein the second cladding layer adheres the first cladding layer and the core to the glass block.

6. The optical waveguide component according to claim 1, wherein the optical waveguide includes:
a first cladding layer disposed on the first surface,
a core disposed on the first cladding layer,
a second cladding layer disposed on the first cladding layer and the core, and
wherein a height of the projection is equal to a thickness of the first cladding layer.

7. The optical waveguide component according to claim 1, further comprising an optical semiconductor chip mounted on the substrate and optically coupled to the optical waveguide.
